(19) United States
(12) Patent Application Publication
(10) Pub. No.: US 2008/0260489 A1
(43) Pub. Date: Oct. 23, 2008

(54) Captured nut assembly

(75) Inventors: Richard S. Brown, Brantford (CA); Gerald W. McCabe, North Street, MI (US)

Correspondence Address: REISING, ETHINGTON, BARNES, KISSELLE, P.C., P O BOX 4390, TROY, MI, 48099-4390, US

(73) Assignee: General Fasteners Company

(21) Appl. No.: 11/789,061

(22) Filed: Apr. 23, 2007

(51) Int. Cl. F16B 39/00

(52) U.S. Cl. 411/176; 411/172

(57) ABSTRACT

A strip has a plurality of slots therein each which has a captured nut freely rotatable in the slot to be assembled to a work piece.

### TECHNICAL FIELD

The field of this invention relates to captured nuts on a work piece.

### BACKGROUND OF THE DISCLOSURE

There are assembly and installation situations where individual nuts are undesirable. In critical installation procedures where quick assembly is required or where the consequences of a loose or separated nut can be severe, nuts are desired to be preinstalled to reduce the risks of a loose or separated nut.

One such critical installation is the mounting of a windage tray to an automotive engine. While the installation of windage tray is desirable to provide a slash barrier between the oil in the oil pan and the crank shaft which may provide an increase in effective horsepower of the engine, the accidental introduction of a separated nut to the internal space of engine assembly may cause extensive damage to the internal engine parts during later operation of the engine.

Captured nuts both rotatable and non-rotatable have been known but are often made with extra members such as washers or the nuts need the aperture to be unthreaded near a capturing collar. Shortening of the threads in a threaded aperture degrades the holding power of a nut.

What is needed is an improved captured nut assembly that reduces the risk of a separated nut.

### SUMMARY OF THE DISCLOSURE

In accordance with one aspect of the invention, a nut assembly has a retaining strip with a plurality of longitudinally spaced slots therethrough. The slots preferably have its length greater than a width. A plurality of nut bodies each have a drive section, a centrally located axially threaded bore, a first abutment shoulder and a collar extending from the first abutment shoulder. Preferably, the slot has a length larger than the diameter of the proximate end of the collar to provide longitudinal sliding movement of the nut along the longitudinal direction of the slot. The longitudinal axis of the slots is preferably substantially extending in the same direction as the longitudinal axis of the flexible retaining strip.

The collar has a proximate end with an outer radius sized no greater than a width of the slot to engage within the slots. The abutment shoulder has a diameter greater than the width of the slot to abut the retaining strip adjacent the slots on one side of the strip. The collar has an integrally formed flange with a diameter greater than the width of the slot and positioned at an opposite side of the strip to secure the strip to the nut between the abutment shoulder and the flange. The flange is formed from a distal and radially outer section of the collar. A distal and radially inner section of the collar has an outer radius smaller than the outer radius of the proximate end.

In one embodiment, the collar has its distal and radially outer section undergoing local disruption to provide the outward extending flange with a diameter greater than the width of the slot. The distal and radially inner section of the collar and the axially threaded bore is substantially undisturbed by the local disruption at the distal and radially outer section. The flange is preferably canted radially outward and axially away from the abutment shoulder. The collar also preferably has its proximate end with the outer radius being sized slightly under the width of the slot to allow the nut to rotate within the slot.

In one embodiment, the retaining strip is contoured with varying width sections. In this embodiment, the retaining strip has its largest width sections containing the slots. The retaining strip is preferably flexibly resilient and normally biased to a flat straight position and made from spring steel.

According to another aspect of the invention, a captured nut has a nut body with a drive section for engagement by a drive tool to rotate the nut body. The nut body has an abutment shoulder at one end. A tubular deformable collar extends from the abutment shoulder. A threaded passage extends through the nut body, abutment shoulder and the tubular deformable collar of a given outer diameter. The threaded passage is threaded in the collar section. The collar has a distal and radially outer section capable of being locally deformed to a greater diameter than the given outer diameter to form an annular groove to be able to capture a work piece about an aperture therethrough. A distal and radially inner section of the collar remaining substantially undeformed and has a portion of the threaded passage passing therethrough.

### BRIEF DESCRIPTION OF THE DRAWINGS

Reference now is made to the accompanying drawings in which:

FIG. 1 is a perspective view of a strip nut being installed with a windage tray in accordance with one embodiment of the invention;

FIG. 2 is a plan view of the strip and nut assembly shown in FIG. 1;

FIG. 3 is an enlarged cross sectional view taken along lines 3-3 shown in FIG. 2;

FIG. 4 is a fragmentary enlarged plan view of two of the nuts and strip with the nuts shown in two different longitudinal positions within the respective slots;

FIG. 5 is a plan view of a modified strip with captured nuts;

FIG. 6 is a side partially segmented view of the captured nut before assembly by local disruption;

FIG. 7 is a side elevation view illustrating an anvil used in the deformation of the nut; and

FIG. 8 is a side elevational and partially segmented view illustrating a modified anvil used in the deformation of a modified nut.

### DETAILED DESCRIPTION OF THE PREFERRED EMBODIMENT

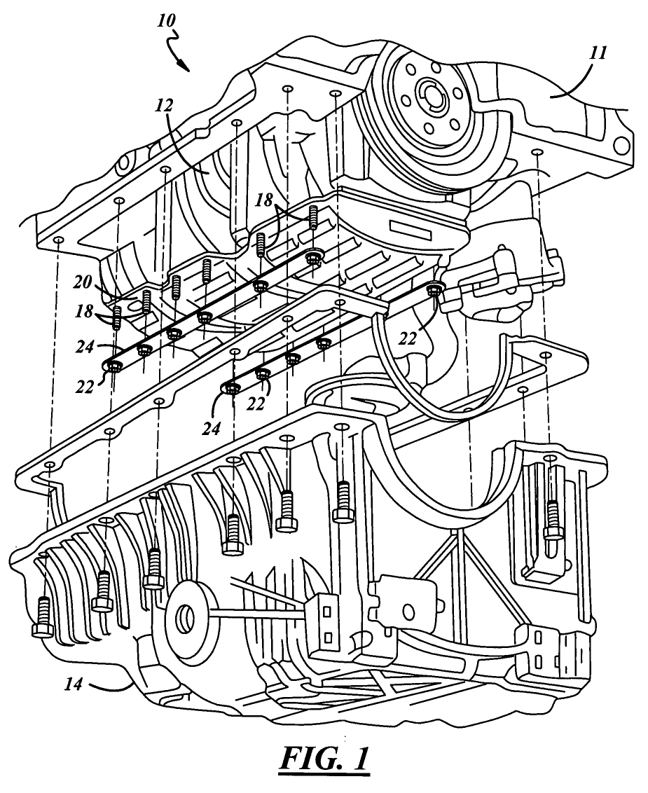

Referring now to FIG. 1, an internal combustion engine 10 has a conventional block 11 and internal parts 12 such as crank arms and crankshaft which are mounted to the underside of the block 11. A plurality of threaded studs 18 extend from the block 11 and engage apertures in the windage tray 20 which is mounted below the crankshaft. A plurality of captured nuts 22 mounted on a flexible strip 24 are threaded onto the studs 18 to affix the windage tray 20 in place. An oil pan 14 is mounted to the underside of the engine block 11 to enclose the windage tray and retains the oil therein.

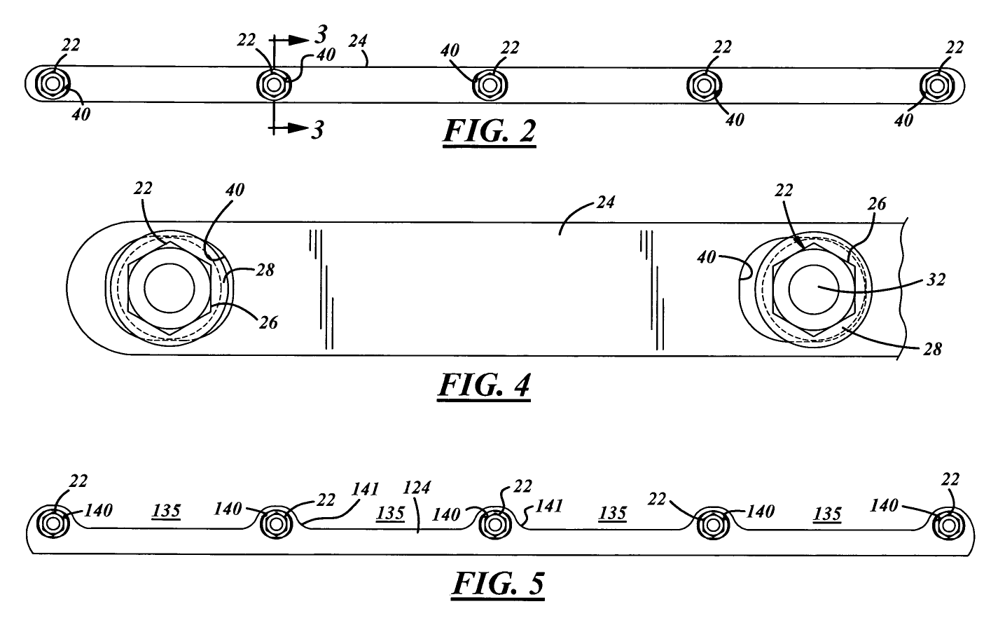

The strip 24 and nuts 22 are more clearly shown in FIGS. 2-4. Each nut 22 has a hex shaped outer drive section 26. The captured nut 22 also has an annular abutment shoulder 28 and an axially extending collar 30. A threaded aperture 32 is centrally located and axially extends entirely through the nut 22. The threads 34 in the aperture 32 fully extend from the upper face 36 and into the collar 30. The distal end may optionally have a chamfer (not shown). The nut may be made from steel such a S.A.E. 1065. Other materials may also be suitable depending on the application.

The strip is made from spring steel and is thin enough to be yieldably resiliently flexible. The rest position of the strip is normally biased to its elongated flat straight position as shown in the Figures. A typical thickness is 0.3 mm for a strip that is about 490 millimeters long and about 19 millimeters wide. Of course different applications may require a different thickness for different amount of desired flexibility and resiliency. Other applications may have the retaining strip being rigid.

The strip 24 has a plurality of elongated slots 40 which are spaced longitudinally along the strip. The slots 40 each have its longitudinal axis extending along the length of the strip. The slots have their width dimensioned to receive the proximate outer diameter section 42 of the collar that is in proximity of the abutment surface. The abutments shoulder 28 has a larger outer diameter to engage the side 44 of the strip about the slots 40.

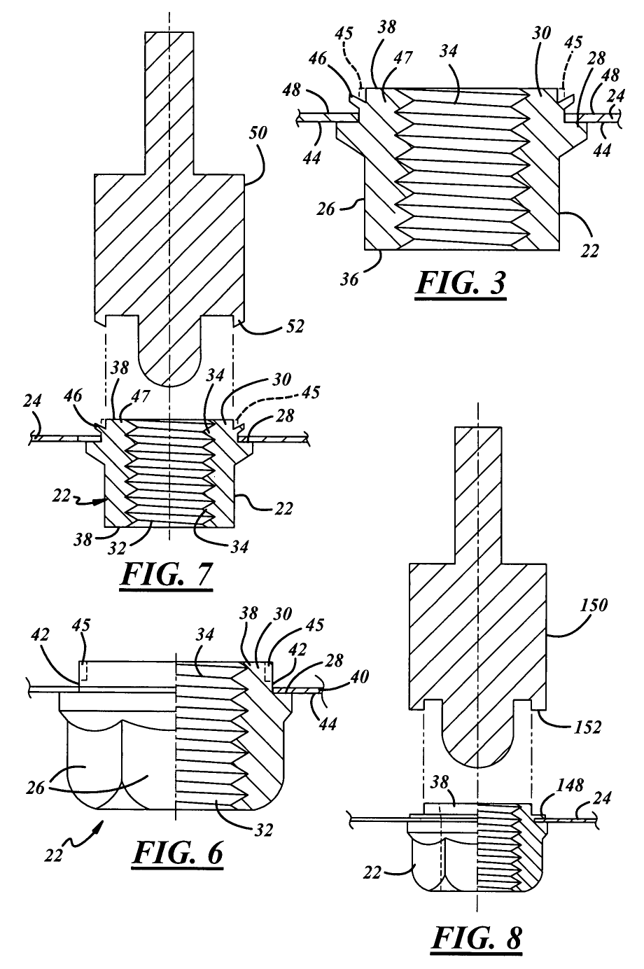

The collar 30 has a axially distal and radially outer section 45 as best shown in FIG. 6 that can be locally disrupted once positioned in the strip 24 to form a radially outwardly extending flange section 46 as shown in FIG. 3 sized to be greater than the width of the slot to engage an opposite side 48 of the strip 40 about the slot 40 to capture the nut 22 in the slot 40. The flange 46 is formed to axially capture the nut in the slot 40 but the nut is not crimped onto the sides 44 and 48 thereby allowing free rotation of the nut 22 in the slot 40. As shown in FIG. 3, some vertical axial movement is allowed between the nut 22 and the strip 24. Further, the flange 46 also allows longitudinal movement of the nut 22 along the length of the slot 40 as best shown in FIG. 4 with each nut 22 shown in a different longitudinal position with its respective slot 40.

The local disruption of the distal and radial outer portion 45 does not affect the radially inner section 47 of the collar nor the threaded aperture 32 with its threads 34. The slots 40 are centrally located to align with the studs 18 such that the nuts 22 can be aligned and threadably engaged and tightened onto the studs 18 sequentially one at a time. The longitudinal freedom of the nut 22 also provides for any manufacturing tolerance so that the nuts 22 can be axially aligned without any cant to eliminate any cross-threading or other improper threading to the studs 18.

The flange 46 as shown in FIG. 3 has a taper or cant radially outward and away from the abutment shoulder 28. As shown in FIG. 7, the taper is formed by an anvil 50 which has a corresponding anvil tapered striker zone 52 that strikes the distal radial outer section 45 of the nut 22 as shown in FIG. 6 such that after striking the anvil it forms the tapered flange 46 as shown in FIG. 7. The nut is appropriately seated on a fixture (not shown) to receive the striking face of the anvil and be deformed by it.

Alternate shaped nut 22 and anvil 150 are shown in FIG. 8. In this embodiment the nut 22 has a horizontally extending flange 148 formed by anvil 150 with striker zone 152 that is similarly horizontally extending. Again the spaced flange 148 and the abutment shoulder 28 are spaced about the strip 24 to axially retain the captured nut 122 but allows for free longitudinal sliding movement in the slot 40 and allows for free rotation of the nut 22 within the slot 40.

The longitudinal positions of the slots 40 may be asymmetrically or irregularly spaced along the strip 24 to correspond to likewise asymmetrically or irregularly positioned studs 18. In this fashion, the strip 24 is not reversible and can only be fitted onto the studs with a single correct position.

As shown in FIG. 5, a modified strip 124 has the slots 140 asymmetrically placed with respect to the main longitudinal axis of the strip 124. The strip 124 is contoured about the slots 140 such that the strip area between two consecutive slots 140 is narrowed and offset from the slots to accommodate rises and shapes of the windage tray with may intrude into the ambient space 135 between two consecutive slots 140. It is also foreseen that the strip edges 141 between the slots may also be contoured to accommodate other intrusions of work pieces such as windage trays.

In this fashion, a strip of captured nuts 22 is easily used in an assembly process to assemble parts in a critical phase of assembly where smaller loose parts may otherwise cause grave consequences. The strip of captured nuts is flexible to accommodate manufacturing tolerances and has the nuts being capable of longitudinal movement along the slot to further accommodate manufacturing tolerances while allowing free rotation to tighten onto a threaded stud or bolt. The threads extend entirely through the internal passage of the nut to retain full gripping power of the nut to the bolt.

Variations and modifications are possible without departing from the scope and spirit of the present invention as defined by the appended claims.

The embodiments in which an exclusive property or privilege is claimed are defined as follows:

1. A nut assembly comprises:
a retaining strip having a plurality of longitudinally spaced slots therethrough;
a plurality of nut bodies each having a drive section, a centrally located axially threaded bore, a first abutment shoulder and a collar extending from said first abutment shoulder;
said collar having a proximate end section with an outer radius sized no greater than said slots to engage within said slots;
said abutment shoulder having a diameter greater than a width of said slot to abut the retaining strip adjacent said slots on one side of said strip;
said collar having an integrally formed flange with a diameter greater than the width of said slot and positioned at an opposite side of said strip to secure said strip to said nut between said abutment shoulder and said flange said flange being formed from a distal and radially outer section of said collar; and
a distal and radially inner section of said collar having an outer radius smaller than said outer radius of said proximate end.

2. A nut assembly as defined in claim 1 further comprising:
said slots having its length greater than a width;
said slot having a length larger than said diameter of said proximate end of said collar to provide longitudinal sliding movement of said nut along the longitudinal direction of said slot.

3. A nut assembly as defined in claim 2 further comprising:
the longitudinal axis of said slots substantially extending in the same direction as the longitudinal axis of said retaining strip.

4. A nut assembly as defined in claim 3 further comprising:
said collar having its distal and radially outer section undergoing local deformation to provide an outward extending flange having a diameter greater than the width of said slot; and
said distal and radially inner section of said collar and said axially threaded bore being substantially undisturbed by said local deformation at said distal and radially outer section.

5. A nut assembly as defined in claim 4 further comprising:
said flange being canted radially outward and axially away from said abutment shoulder.

6. A nut assembly as defined in claim 1 further comprising:
said collar having its proximate end section with said outer radius being sized slightly under the width of said slot to allow said nut to rotate in said slot.

7. A nut assembly as defined in claim 6 further comprising:
said flexible retaining strip being contoured with varying width sections.

8. A nut assembly as defined in claim 7 further comprising:
said retaining strip having largest width sections containing said slots.

9. A nut assembly as defined in claim 8 further comprising:
said retaining strip being flexibly resilient and normally biased to a flat straight position.

10. A nut assembly as defined in claim 9 further comprising:
said flexible retaining strip being made from spring steel.

11. A nut assembly as defined in claim 10 further comprising:
said collar having its distal and radially outer section undergoing local deformation to provide an outward extending flange having a diameter greater than the width of said slot; and
said distal and radially inner section of said collar and said axially threaded bore being substantially undisturbed by said local deformation at said distal and radially outer section.

12. A nut assembly as defined in claim 11 further comprising:
said flange being canted radially outward and axially away from said abutment shoulder.

13. A nut assembly as defined in claim 10 further comprising:
said slot having a length larger than said diameter of said proximate end of said collar to provide longitudinal sliding movement of said nut along the longitudinal direction of said slot.

14. A nut assembly as defined in claim 13 further comprising:
the longitudinal axis of said slots substantially extending in the same direction as the longitudinal axis of said flexible retaining strip.

15. A nut assembly as defined in claim 8 further comprising:
said slot having a length larger than said diameter of said proximate end of said collar to provide longitudinal sliding movement of said nut along the longitudinal direction of said slot.

16. A nut assembly as defined in claim 15 further comprising:
the longitudinal axis of said slots substantially extending in the same direction in the longitudinal axis of said retaining strip.

17. A nut assembly as defined in claim 16 further comprising:
said collar having its distal and radially outer section undergoing local deformation to provide an outward extending flange having a diameter greater than the width of said slot; and
said distal and radially inner section of said collar and said axially threaded bore being substantially undisturbed by said local deformation at said distal and radially outer section.

18. A captured nut comprising:
a nut body having a drive section being engageable by a drive tool to rotate the nut body;
said nut body having an abutment shoulder at one end thereof;
a tubular deformable collar extending from said abutment shoulder;
a threaded passage extending through said nut body, abutment shoulder and said tubular deformable collar of a given outer diameter;
said threaded passage being threaded into the collar;
said collar having a distal and radially outer section capable of being locally deformed to a greater diameter than said given outer diameter to form an annular groove to be able to capture a work piece about an aperture through said work piece; and
a distal and radially inner section of said collar remaining substantially undeformed and having a portion of said threaded passage passing therethrough.
